(19) United States
(12) Patent Application Publication
(10) Pub. No.: US 2022/0338697 A1
(43) Pub. Date: Oct. 27, 2022

(54) CLEANER SYSTEM

(71) Applicant: LG ELECTRONICS INC., Seoul (KR)

(72) Inventors: Donghoon KWAK, Seoul (KR); Hyeokjoo YUN, Seoul (KR); Jaehwan KO, Seoul (KR)

(21) Appl. No.: 17/761,687

(22) PCT Filed: Sep. 7, 2020
(86) PCT No.: PCT/KR2020/012046

§ 371 Date: Mar. 18, 2022

(30) Foreign Application Priority Data
Oct. 17, 2019 (KR) 10-2019-0129234

(51) Int. Cl. A47L 9/28; A47L 5/28

(52) U.S. Cl. CPC A47L 9/2894; A47L 5/28; A47L 9/2884; A47L 9/2857; H04M 1/72412

(57) ABSTRACT

Provided is a cleaner system, according to one embodiment of the present disclosure, which comprises a terminal and a cleaner provided to be capable of wireless communication with the terminal. The cleaner comprises: a main body; a cleaning unit provided in the main body; a communication unit that wirelessly communicates with an external terminal; a control unit for processing information on the cleaner; and a battery for providing power, wherein the terminal visually provides information transmitted from the cleaner to a user. According to embodiments of the present disclosure, it is possible to enable a user to easily grasp information on the cleaner even if the user does not pay great attention to the cleaner, and to catch the user's attention by means of an alarm.

### TECHNICAL FIELD

The present disclosure relates to a cleaner system.

### BACKGROUND ART

These days, various kinds of home-IoT-based electronic products are produced. With this trend, users continuously learn the use of electronic products through various media, such as advertisements, manuals, and videos, in order to increase the usability of electronic products.

Furthermore, there are some commercialized electronic products that enable users to control the operation thereof using smartphones familiar to the users.

However, most users merely control activation or inactivation of home-IoT-based electronic products or control temperature using the same. If users pay little attention to home-IoT-based electronic products, the users may not be capable of effectively using the same.

Therefore, research is constantly being conducted on a method of utilizing functions of electronic products more conveniently and more simply.

In particular, with regard to activities that need to be frequently performed, such as cleaning, if a user does not pay close attention thereto, it may be difficult for the user to enjoy comfortable life.

### DISCLOSURE

### Technical Task

Embodiments of the present disclosure provide a cleaner system that provides a user with information using various alarm functions.

In addition, embodiments of the present disclosure provide a cleaner system that reminds a user of cleaning using an alarm function.

In addition, embodiments of the present disclosure provide a cleaner system that maximizes user convenience.

As an example for accomplishing the above tasks, there is provided a cleaner system in which a terminal, which receives information from a cleaner, not only visually provides the information to a user, but also draws user's attention using various types of alarm functions.

Describing in detail, in a cleaner system including a terminal and a cleaner configured to communicate with the terminal in a wireless manner, the cleaner includes a main body, a cleaning unit provided in the main body, a driving unit coupled to the main body to move the main body, a sensing unit configured to sense image information about the surroundings of the main body, a transceiver configured to communicate with an external terminal in a wireless manner, a controller configured to control operation of the driving unit, and a battery configured to supply power. The terminal visually provides information transmitted from the cleaner to a user.

In addition, the terminal may include a display configured to display information transmitted from the cleaner.

In addition, the display may display a first section indicating a non-cleaning time period and an average cleaning time.

In addition, upon sensing that the cleaner has not been operated for a predetermined time period, the terminal may notify the user of a result of sensing using an alarm function.

In addition, when the first section is selected, the display may display the average cleaning time to the user in the form of a graph in units of weeks or months.

In addition, the cleaner may include a speaker, and the display may display a second section enabling the user to control the cleaner to reproduce music or a radio broadcast.

In addition, the display may display a third section indicating a remaining capacity of the battery and an available cleaning time corresponding to the remaining capacity of the battery.

In addition, the display may display a fourth section indicating a time remaining until completion of charging of the cleaner.

In addition, when the cleaner is completely charged, the terminal may notify the user of completion of charging using an alarm function.

In addition, the display may display a fifth section indicating a replacement time of a filter provided in the cleaner.

In addition, upon sensing that the replacement time of the filter has been reached or that the filter is clogged, the terminal may notify the user of a result of sensing using an alarm function.

### Advantageous Effects

Embodiments of the present disclosure may remind a user of a cleaning period or cleaning using an alarm function even if the user pays no attention to a cleaner.

In addition, the user may easily perceive information on the cleaner through a terminal.

In addition, the user may be easily reminded of cleaning by visually provided information.

### DESCRIPTION OF DRAWINGS

FIG. 1 is a view showing a cleaner system according to an embodiment of the present disclosure.

FIG. 2 is a block diagram showing connection relationships between components in a cleaner system according to an embodiment of the present disclosure.

FIGS. 3 to 6 are diagrams showing a display T1 of a terminal T of a cleaner system 10 according to an embodiment of the present disclosure.

### BEST MODE FOR DISCLOSURE

Hereinafter, exemplary embodiments of the present disclosure will be described with reference to the accompanying drawings. The following description is provided in order to provide a comprehensive understanding with respect to a method, a device, and/or a system described herein. However, this is merely for illustrative purposes, and the present disclosure is not limited thereto.

In the following description of the exemplary embodiments of the present disclosure, when it is determined that a detailed description of a well-known technology related to the present disclosure can unnecessarily obscure a subject matter of the present disclosure, the description will be omitted. Also, the terms used in the following description are terms defined taking into consideration the functions obtained in accordance with the present disclosure, and may be changed in accordance with the option of a user or operator or a usual practice. Therefore, the definitions of these terms should be determined based on the whole content of this specification. The terms used herein are only for describing exemplary embodiments according to the present disclosure, and should not be interpreted as being restrictive. As used herein, the singular forms are intended to include the plural forms as well, unless the context clearly indicates otherwise. It will be further understood that the terms “comprises”, “comprising”, “includes”, and/or “including”, when used herein, specify the presence of stated features, integers, steps, operations, elements, components, or combinations thereof, but do not preclude the presence or addition of one or more other features, integers, steps, operations, elements, components, or combinations thereof.

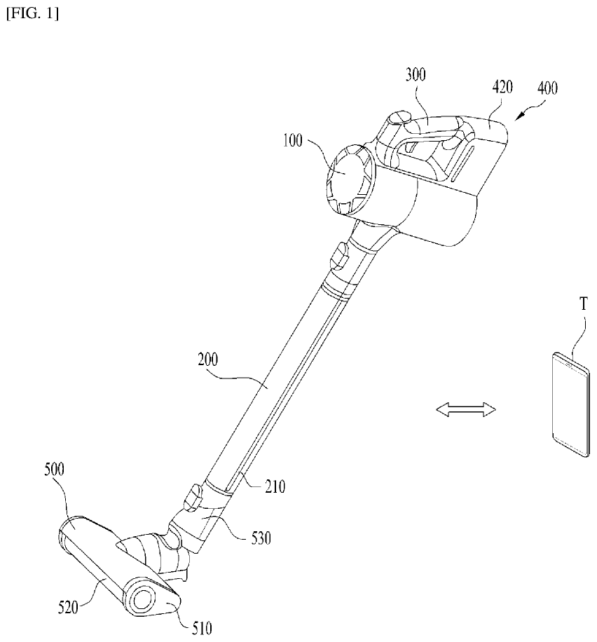

FIG. 1 is a view showing a cleaner system according to an embodiment of the present disclosure.

A cleaner system 10 according to an embodiment of the present disclosure may include a cleaner 1. The cleaner 1 may include a main body 100, a cyclone unit (not shown), an extension pipe 200, a suction nozzle 500, and a battery unit 400.

The suction nozzle 500 is a part that suctions air containing dust in a cleaning target area. Air suctioned through the suction nozzle 500 may be introduced into the main body 100, which will be described later, through the extension pipe 200.

The suction nozzle 500 may include a suction nozzle housing 510, a connection pipe 530, and a rotary cleaning part 520.

The suction nozzle 500 may be provided such that the rotary cleaning part 520 and the connecting pipe 530 are coupled to the suction nozzle housing 510 in order to clean the cleaning target area.

Specifically, the suction nozzle housing 510 may be formed to have an open front portion. In addition, the suction nozzle housing 510 may be formed such that the portion thereof that is brought into contact with the floor has a large area in order to prevent the user from unnecessarily moving a lot when cleaning.

The rotary cleaning part 520 may be disposed in the open portion in the suction nozzle housing 510. The rotary cleaning part 520 may be rotatably coupled to the suction nozzle housing 510. The rotary cleaning part 520 in the suction nozzle housing 510 may be rotated by a separate driving unit (not shown).

When the rotary cleaning part 520 is rotated, the dust on the floor in the cleaning target area instantly floats in the air, and is easily introduced into the cleaner 1 by the suction force generated by the suction nozzle 500.

The connection pipe 530 may serve to induce air containing dust into the extension pipe 200. That is, when air containing dust is introduced into the suction nozzle 500, the same may be conveyed into the extension pipe 200, which will be described later, through the connection pipe 530.

The extension pipe 200 may be a passage through which air containing dust introduced by the suction nozzle 500 moves. The user is capable of using the cleaner in a standing state due to the extension pipe.

The function of the cleaner 1 may be executed without the extension pipe 200. However, the suction nozzle 500 is generally used in the state in which the same is in contact with the floor. Thus, if there is no extension pipe, the user needs to bend his/her waist or sit in order to perform cleaning.

However, the present disclosure is not limited thereto. In the case in which the connection pipe 530 of the suction nozzle 500 is formed to be extendable, the connection pipe 530 may serve as the extension pipe 200. In this case, the suction nozzle 500 and the main body 100 may be formed integrally with each other.

The main body 100 may provide a space in which to accommodate the cyclone unit, which will be described later. The main body 100 may have an external appearance that allows the air suctioned by a suction motor (not shown) to be introduced thereinto through the suction nozzle 500 and assists the introduced air in generating a cyclone.

The main body 100 may be provided with a suction portion (not shown) that communicates with the extension pipe 200. Accordingly, the suction force generated by the suction motor provided in the main body 100 may be transferred to the extension pipe 200 and the suction nozzle 500. Accordingly, the user is capable of performing cleaning by suctioning air containing dust from the floor in the cleaning target area in a standing state.

The cyclone unit may be provided in the main body 100 to separate dust from air using cyclonic flow. Specifically, the inner circumferential surface of the main body 100 may serve as a first cyclone unit. The rotation axis of the cyclonic flow of the cyclone unit may be provided parallel to the longitudinal direction of the main body 100. Preferably, the longitudinal axis passing through the center of the first cyclone unit may be the rotation axis.

The cyclonic flow will now be described in detail. The air introduced into the main body 100 by the suction unit may flow spirally along the inner circumferential surface of the first cyclone unit. When air containing dust flows spirally along the inner circumferential surface of the first cyclone unit, heavy dust particles may be thrown to the periphery of the first cyclone unit by centrifugal force. When the centrifugal force increases, the heavy dust particles may be deposited on the bottom surface of the first cyclone unit. Therefore, only air may continue to flow, and accordingly, large or heavy dust particles may be primarily filtered.

The cyclone unit may include a second cyclone unit. The second cyclone unit may be provided in the first cyclone unit.

The second cyclone unit may include cyclone bodies (not shown) disposed in parallel. The second cyclone unit may separate dust, which has not been filtered by the first cyclone unit, from air. A filter (not shown) may be disposed inside the second cyclone unit. Thus, when air flows therein, dust may be naturally filtered.

The dust filtered by the first cyclone unit and the dust filtered by the second cyclone unit may be collected separately.

However, the configuration of the cyclone unit is not limited to the above-described example, and the cyclone unit may be operated in any other manner, so long as the same has a configuration capable of separating dust using air flow.

A handle unit 300, which is formed to be gripped by the user, may be coupled to the main body 100. The handle unit 300 may be formed to provide a space into which the user is capable of inserting his/her fingers in order to grip the same.

A manipulation unit 310 may be provided in the space into which the user's fingers can be inserted, so the user is capable of easily using a finger to change the suction intensity or the cleaning mode of the cleaner. The cleaner 1 according to an embodiment of the present disclosure may include a battery unit 400.

The battery unit 400 may include a battery (not shown) and a battery unit case.

In this case, the battery may serve to supply power to a suction motor (not shown). However, this does not mean that the battery supplies power only to the suction motor 150. The battery may also supply power to a driving unit of the rotary cleaning part 520. In the case in which other electronic components are provided in the cleaner 1, the battery may also supply power to the electronic components.

The battery unit case may be formed to provide a space in which to accommodate the battery.

The battery unit case may form the external appearance of the battery unit 400. The battery unit may be formed integrally with the above-described handle unit 300.

That is, the battery unit 400 may be coupled to the main body 100. Because the battery unit 400 is coupled to the main body 100 accommodating the cyclone unit, a greater suction force may be generated.

Preferably, the battery unit case 420 may be disposed below the handle unit 300. When the battery is disposed below the handle unit 300, the user may easily hold the cleaner 1.

In general, the battery accounts for a large proportion of the weight of the cleaner 1. Thus, if the battery unit case 420 is disposed above the handle unit 300, a large force may be applied to the user's wrist, and thus it may be inconvenient for the user to use the cleaner 1.

Although the above description has been made with reference to an upright (stick)-type cleaner, the present disclosure is not limited thereto. The above description is also applicable to a canister-type cleaner.

In addition, the cleaner system 10 according to an embodiment of the present disclosure may include a terminal T, which is provided separately from the cleaner 1.

The terminal T may be a mobile phone. However, the terminal T is not limited thereto, so long as the same is capable of communicating with the cleaner 1 in a wireless manner.

The terminal T may include a display T1. The display T1 may be implemented as a touch screen capable of recognizing a user's touch. The display T1 may serve to receive information from the cleaner 1 and to visually transmit the information to the user.

There is no limitation as to the size or shape of the terminal T.

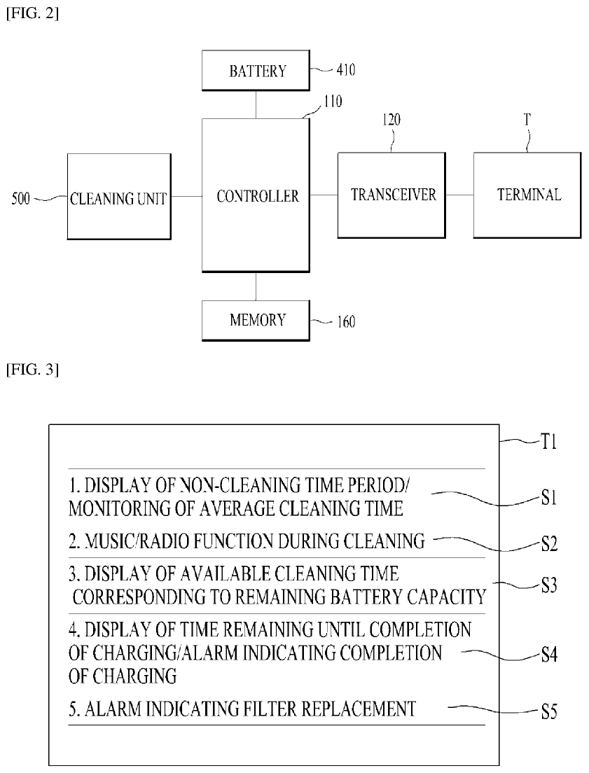

FIG. 2 is a block diagram showing connection relationships between components in a cleaner system according to an embodiment of the present disclosure.

Referring to FIG. 2, the cleaner 1 according to an embodiment of the present disclosure may further include a controller 110, a memory 160, and a transceiver 120.

The memory 160 may store cleaning history information. The cleaning history information may be generated whenever cleaning is performed, and may be transmitted to the external terminal T through the controller 110. The cleaning history information may include a non-cleaning time period and a time spent cleaning. A detailed description thereof will be made later.

The transceiver 120 may be configured to communicate with an external device in a wireless manner. Accordingly, the cleaner 1 may be controlled by the external device. In addition, the cleaner 1 may recognize the position thereof in the cleaning area through communication with a charging station or other devices.

Specifically, the controller 110 may receive not only cleaning history information but also information on the state of charge of the battery. The controller 110 may determine the remaining capacity of the battery 410. The controller 110 may calculate an available time of the cleaner 1 based on the remaining capacity of the battery 410. Accordingly, the cleaner 1 may notify the user of the available cleaning time corresponding to the remaining capacity of the battery 410.

That is, the controller 110 may process information about the cleaner 1, and may transmit the information to the terminal T through the transceiver.

FIGS. 3 to 6 are diagrams showing the display T1 of the terminal T of the cleaner system 10 according to an embodiment of the present disclosure.

The following description will be given with reference to FIGS. 3 to 6.

The user may perceive at least one of a first section S1, a second section S2, a third section S3, a fourth section S4, or a fifth section S5 through the display T1 of the terminal T.

Specifically, the first section S1 may be an item that indicates a time period for which the cleaner 1 has not been operated, that is, a non-cleaning time period, and an average cleaning time.

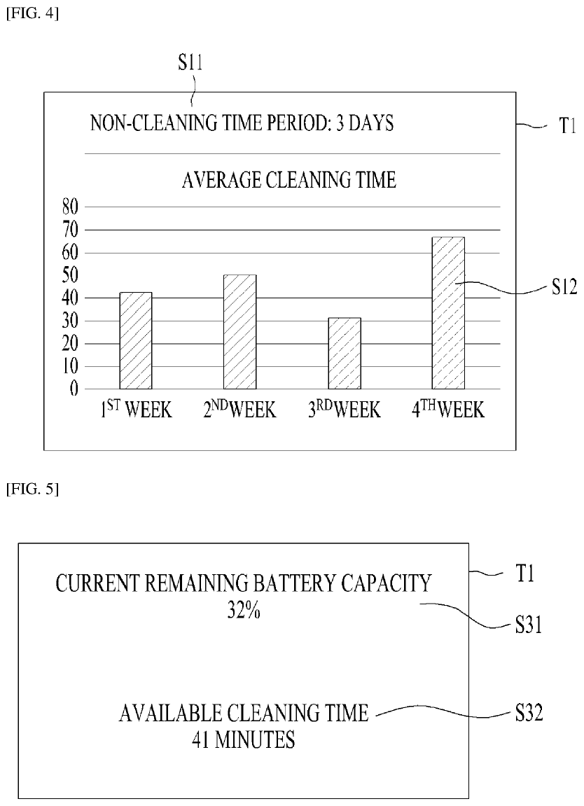

Describing in detail with reference to FIGS. 3 and 4, when the user selects the first section S1 on the display T1, the user may visually check the non-cleaning time period.

Accordingly, this may remind the user of cleaning, and may assist the user in paying close attention to a cleaning period and establishing a cleaning plan.

Furthermore, when cleaning is not performed for a predetermined time period, the user may be reminded of cleaning by the alarm function performed through the terminal T. In this case, the alarm function may be performed using at least one of vibration, sound, or light. However, the present disclosure is not limited thereto. Any type of alarm may be employed, so long as the same is capable of reminding the user of a cleaning period.

When the first section S1 is selected, not only the non-cleaning time period S11 but also the average cleaning time S12 may be displayed. Although this information is illustrated in the drawings as being displayed in units of weeks, the same may also be displayed in any of various units, for example, in units of days, in units of one cleaning operation, or in units of months.

The average cleaning time S12 may be displayed on the display T1 in the form of a bar graph so that the user is capable of intuitively perceiving the same. Thus, the user is capable of intuitively perceiving the cleaning time per a predetermined unit time (or per every cleaning operation).

If the average cleaning time S12 is displayed in the form of a bar graph, the user is capable of easily perceiving the cleaning time trend without checking the specific time, and is thus capable of guessing whether the cleaning target area is clean or not at the present time.

The second section S2 may be an item that enables the user to reproduce music or a radio broadcast when cleaning. Although the second section S2 is illustrated in the drawings as being expressed as “MUSIC/RADIO FUNCTION DURING CLEANING”, setting may be made such that only one of the music function and the radio function is executed. Although not illustrated in the drawings, in the case in which setting is made such that both the music function and the radio function are executed, when the second section S2 is selected, a separate screen may be displayed on the display T1.

In order to reproduce music or a radio broadcast, the cleaner 1 may include a speaker. The cleaner 1 may be configured to read a USB drive or an external device through the memory 160 or a separate input unit (not shown) in order to reproduce music. However, when a smartphone reproduces music or a radio broadcast without a separate storage in the manner of being interlocked with the terminal T, it is preferable for the cleaner 1 to reproduce the same through the speaker thereof.

Referring to FIGS. 3 and 5, the display T1 may be controlled to display the third section S3.

The third section S3 may be an item that indicates information on the remaining capacity of the battery 410. When the third section S3 is selected by the user, the current remaining battery capacity S31 of the cleaner 1 and the available cleaning time S32 corresponding to the current remaining battery capacity may be displayed.

Accordingly, the user is capable of determining whether to charge the cleaner 1 and establishing a detailed cleaning plan.

In detail, the user is capable of determining whether charging is necessary based on the remaining battery capacity. Since the available cleaning time corresponding to the remaining battery capacity is displayed, the user is capable of determining whether a cleaning operation can be performed without charging by comparing the available cleaning time with the average cleaning time indicated by the first section S1.

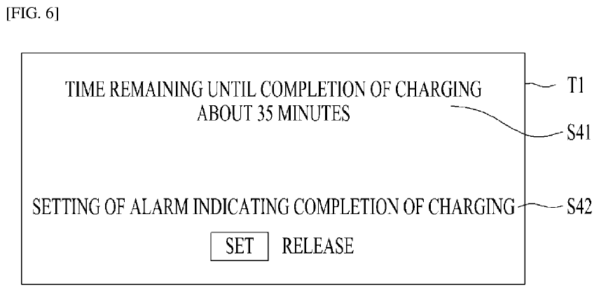

Referring to FIGS. 3 and 6, the display T1 may be controlled to display the fourth section S4.

The fourth section S4 may be an item that indicates the time remaining until completion of charging. When the fourth section S4 is selected by the user, the time S41 remaining until completion of charging of the cleaner 1 and a menu S42 enabling selection as to whether to set an alarm indicating completion of charging may be displayed.

Through the fourth section S4, the user is capable of predicting the charging completion time of the cleaner 1, and is capable of easily perceiving completion of charging of the battery 410 by setting an alarm even if the user pays no attention to the charging rate and the charging time.

As described above, there is no limitation as to the type of alarm.

Referring to FIG. 3, the display T1 may be controlled to display the fifth section.

The fifth section S5 may be an item that indicates the replacement time of a filter (not shown) provided in the cleaner 1.

Although not illustrated in the drawings, when the fifth section S5 is selected by the user, the filter replacement time may be displayed on the display T1. Because the filter is a consumable and thus needs to be periodically replaced, the replacement time may be displayed in consideration of the latest replacement of the filter by the user.

In addition, when the filter is clogged during operation of the cleaner 1 and thus cleaning is not smoothly performed, the user is capable of perceiving this situation through an alarm. Accordingly, the user is capable of determining whether the filter is clogged without needing to inspect the interior of the cleaner 1 or to examine carefully the cleaning state of the cleaner 1.

While the representative exemplary embodiments of the present disclosure have been described in detail, a person skilled in the art to which the present disclosure pertains will understand that variations can be made to the exemplary embodiments without departing from the scope of the present disclosure. Therefore, the scope of the present disclosure should not be limited to the described exemplary embodiments, and should be determined by the claims to be described below and their equivalents.

What is claimed is:

1. A cleaner system comprising a terminal and a cleaner configured to communicate with the terminal in a wireless manner, wherein the cleaner comprises:
a main body;
a cleaning unit provided in the main body;
a transceiver configured to communicate with an external terminal in a wireless manner;
a battery configured to supply power to the cleaner and to be rechargeable; and
a controller configured to process information about the cleaner, and
wherein the terminal visually provides information transmitted from the cleaner to a user.

2. The cleaner system of claim 1, wherein the terminal comprises a display configured to display information transmitted from the cleaner.

3. The cleaner system of claim 2, wherein the display displays a first section indicating a non-cleaning time period and an average cleaning time.

4. The cleaner system of claim 3, wherein, upon sensing that the cleaner has not been operated for a predetermined time period, the terminal notifies a user of a result of sensing using an alarm function.

5. The cleaner system of claim 3, wherein, when the first section is selected, the display displays the average cleaning time to a user in a form of a graph in units of weeks or months.

6. The cleaner system of claim 2, wherein the cleaner comprises a speaker, and
wherein the display displays a second section enabling a user to control the cleaner to reproduce music or a radio broadcast.

7. The cleaner system of claim 2, wherein the display displays a third section indicating a remaining capacity of the battery and an available cleaning time corresponding to the remaining capacity of the battery.

8. The cleaner system of claim 2, wherein the display displays a fourth section indicating a time remaining until completion of charging of the cleaner.

9. The cleaner system of claim 8, wherein, when the cleaner is completely charged, the terminal notifies a user of completion of charging using an alarm function.

10. The cleaner system of claim 2, wherein the display displays a fifth section indicating a replacement time of a filter provided in the cleaner.

11. The cleaner system of claim 10, wherein, upon sensing that the replacement time of the filter has been reached or that the filter is clogged, the terminal notifies a user of a result of sensing using an alarm function.
